(19) United States
(12) Patent Application Publication
(10) Pub. No.: US 2008/0019273 A1
(43) Pub. Date: Jan. 24, 2008

(54) Method for Call Traffic Management in Asb of Cdma 1X System

(75) Inventor: Jun Ho Lee, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UT STARCOM KOREA LIMITED, KYONGKI-DO KOREA (KR)

(21) Appl. No.: 10/586,094

(22) PCT Filed: Jan. 14, 2005
(86) PCT No.: PCT/KR05/00143

§ 371 Date: May 1, 2007

(30) Foreign Application Priority Data
Jan. 15, 2004 (KR) 10-2004-0002986

(51) Int. Cl. H04B 7/155

(52) U.S. Cl. 370/235

(57) ABSTRACT

The present invention relates to a method for processing call traffic in an ATM Switch Block (ASB) in a CDMA 1x system. The CDMA 1x system comprises a Base Transceiver System (BTS), which comprises an OA, a High-speed Transfer and Selector Block (HTSB), an ATM Switch Block (ASB), an ATM Traffic Block (ATB) and a MMCA, and a Base Transceiver System (BTS), which is coupled to a Call Control Processor (CCP). When a request for call setup is transferred from the BTS to the CCP, a traffic path between the OA and the MMCA is set up through performing the claimed method. The present invention removes unnecessary traffic paths so as to utilize system resources efficiently while optimizing system performance.

### TECHNICAL FIELD

The present invention generally relates to a method for processing call traffic in an ATM Switch Block (ASB) in a CDMA 1x system, and more particularly to a method for processing call traffic in order to efficiently utilize system resources and optimize system performance.

### BACKGROUND ART

As shown in FIG. 1, Call Control Processor (CCP; 10) informs High-speed Transfer and Selector Block (HTSB; 40) and ATM Traffic Block (ATB; 30) of each traffic resource such as channel, vocoder, etc., through establishing communications between HTSB (40) and CCP (10) and between CCP (10) and ATB (30) of BTS (50). Then, HTSB (40) and ATB (30), when receiving traffic data, determine whether the data received from CCP (10) is to be directed to Operations Application (OA; 52) or Multi-rate Channel Card Assembly (MMCA; 51) in order to transfer the data. In this structure, CCP (10) informs HTSB (40) and ATB (30) of each other's information to process the traffic. HTSB (40) and ATB (30), upon receiving traffic data, map the table of the data received from CCP (10) in order to process them. Thus, there is a problem in that processing a cell requires a lot of protocol to be performed.

Further, HTSB (40) and ATB (30) manage each other's resources, thus consuming further resources. Thus, when a call for resource is made for a handoff, it may be impossible to process the call, thus leading to the rejection of the call.

### DISCLOSURE OF THE INVENTION

The object of the present invention is to resolve the above-mentioned problems. According to the present invention, upon a request for call setup from a BTS, a CCP assigns an available vocoder resource to an ASB and the ASB sets up a path between the channel and the vocoder so that the traffic data can be transferred through the path. Thus, the present invention provides a method for processing the call traffic in an ASB of a CDMA 1X system, which can save resources and utilize the system efficiently, thus enhancing the stability of the system.

To accomplish the above-mentioned object, the method for processing the traffic call in a CDMA 1x system, wherein the system comprises a Base Transceiver System (BTS). The BTS comprises an Operations Application (OA), a High-speed Transfer and Selector Block (HTSB), an ATM Switch Block (ASB), an ATM Traffic Block (ATB) and a Multi-rate Channel Card Assembly (MMCA), and a Base station Control System (BCS), which is coupled to a Call Control Processor (CCP). The method sets up a traffic path between the OA and the MMCA in response to a request for call setup being transferred from the BTS to the CCP. Such method comprises the steps of:

the ASB's receiving a request for traffic connection setup from the CCP;

the ASB's connecting a path of the OA and a path of the MMCA individually and independently; and

the ASB's reporting completion of traffic setup to the CCP.

To accomplish the above-mentioned object, there is a method for processing the traffic call in a CDMA 1x system, wherein the system comprises a Base Transceiver System (BTS). The BTS comprises an Operations Application (OA), a High-speed Transfer and Selector Block (HTSB), an ATM Switch Block (ASB), an ATM Traffic Block (ATB) and a Multi-rate Channel Card Assembly (MMCA), and a Base station Control System (BCS), which is coupled to a Call Control Processor (CCP). The method releases a traffic path between the OA and the MMCA in response to a request for call release being transferred from the BTS to the CCP. Such method comprises the steps of:

the ASB's receiving a request for traffic release setup from the CCP;

the ASB's releasing a path of the OA and a path of the MMCA individually and independently; and

the ASB's reporting completion of traffic release to the CCP.

### BRIEF DESCRIPTION OF DRAWINGS

FIG. 1 is a functional block diagram for implementing a conventional method for processing call traffic in a CDMA 1X system.

FIG. 2 is a functional block diagram for implementing a method for processing call traffic in an ASB of a CDMA 1X system according to the present invention.

FIG. 3 is a flow chart showing a setup method according to the method for processing call traffic in an ASB of a CDMA 1X system shown in FIG. 2.

FIG. 4 is a flow chart showing a release method according to the method for processing call traffic in an ASB of a CDMA 1X system shown in FIG. 2.

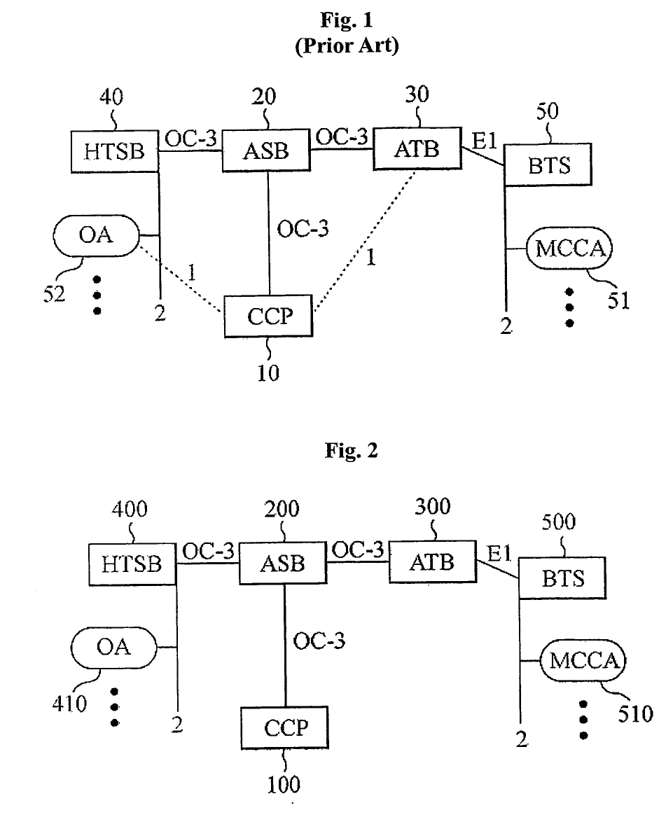

### BEST MODE FOR CARRYING OUT THE INVENTION

The method for processing call traffic in an ASB of a CDMA 1X system according to an embodiment of the present invention will be described with reference to the accompanying drawings.

FIG. 2 is a functional block diagram for implementing a method for processing call traffic in an ASB of a CDMA 1X system according to an embodiment of the present invention. An apparatus for implementing the method for processing call traffic in an ASB of a CDMA 1X system according to an embodiment of the present invention comprises Base Transceiver System (BTS; 500). The BTS 500 comprises Operations Application (OA; 410), High-speed Transfer and Selector Block (HTSB; 400), ATM Switch Block (ASB; 200), ATM Traffic Block (ATB; 300) and Multi-rate Channel Card Assembly (MMCA; 510), and Base station Control System (BCS), which comprises Call Control Processor (CCP; 100).

The method for processing the call traffic in an ASB of a CDMA 1X system with the above-described structure is described below with reference to FIG. 2.

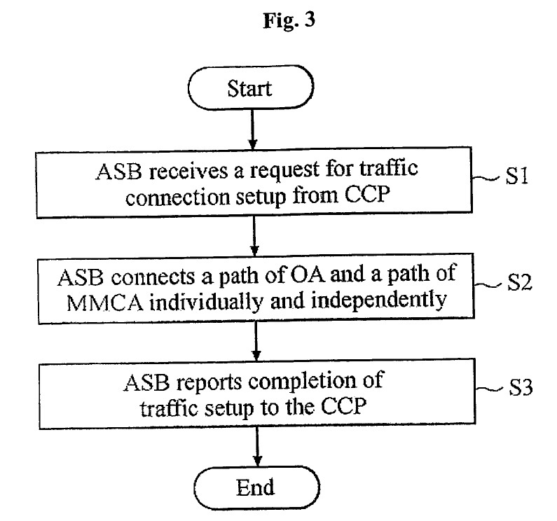

The CDMA 1X system comprises BTS (500), which comprises OA (410), HTSB (400), ASB (200), ATB (300) and MMCA (510), and BCS, which comprises CCP (100). As shown in FIG. 3, when a request for call setup is transferred from BTS (500) to CCP (100), a traffic path between OA (410) and MMCA (510) is set up according to the following steps:

ASB (200) receives a request for traffic connection setup from CCP (100) (S1).

ASB (200) connects a path of OA (410) and a path of MMCA (510) individually and independently (S2).

ASB (200) reports completion of traffic setup to CCP (100) (S3).

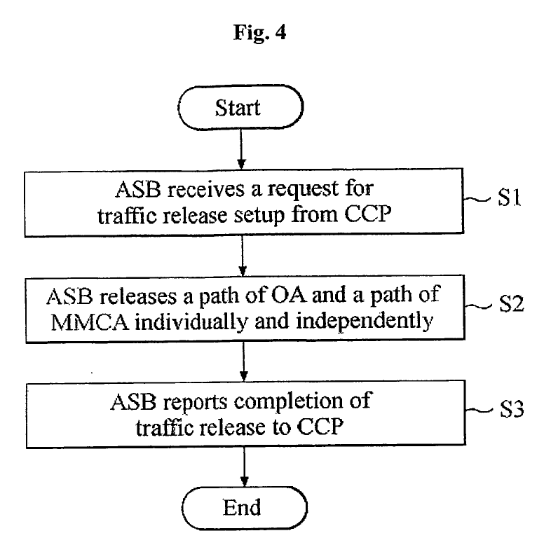

On the other hand, in a CDMA 1X system comprising BTS (500), which comprises OA (410), HTSB (400), ASB (200), ATB (300) and MMCA (510), and BCS, which comprises CCP (100), as shown in FIG. 4, when a request for call release is transferred from BTS (500) to CCP (100), a traffic path between OA (410) and MMCA (510) is released according to the following steps:

ASB (200) receives a request for traffic release setup from CCP (100) (S1).

ASB (200) releases a path of OA (410) and a path of MMCA (510) individually and independently (S2).

ASB (200) reports completion of traffic release to CCP (100) (S3).

### INDUSTRIAL APPLICABILITY

As described above, the method for processing call traffic in an ASB of a CDMA 1X system according to the present invention removes unnecessary traffic paths so as to utilize the system resources efficiently while optimizing the system performance.

Further, according to the present invention, the traffic path setup is managed by an ASB, thus leading to shorter path setup time. The present invention removes the paths upon call release to reuse and make the most of the system resources.

1. A method for processing traffic call in a CDMA 1x system, wherein the system comprises a Base Transceiver System (BTS), which comprises an Operations Application (OA), a High-speed Transfer and Selector Block (HTSB), an ATM Switch Block (ASB), an ATM Traffic Block (ATB) and a Multi-rate Channel Card Assembly (MMCA), and a Base station Control System (BCS), which is coupled to a Call Control Processor (CCP) and wherein the method sets up a traffic path between the OA and the MMCA in response to a request for call setup being transferred from the BTS to the CCP, the method comprising the steps of:
the ASB's receiving a request for traffic connection setup from the CCP;
the ASB's connecting a path of the OA and a path of the MMCA individually and independently; and
the ASB's reporting completion of traffic setup to the CCP.

2. A method for processing traffic call in a CDMA 1x system, wherein the system comprises a Base Transceiver System (BTS), which comprises an Operations Application (OA), a High-speed Transfer and Selector Block (HTSB), an ATM Switch Block (ASB), an ATM Traffic Block (ATB) and a Multi-rate Channel Card Assembly (MMCA), and a Base station Control System (BCS), which is coupled to a Call Control Processor (CCP) and wherein the method releases a traffic path between the OA and the MMCA in response to a request for call release being transferred from the BTS to the CCP, the method comprising the steps of:
the ASB's receiving a request for traffic release setup from the CCP;
the ASB's releasing a path of the OA and a path of the MMCA individually and independently; and
the ASB's reporting completion of traffic release to the CCP.
